(19) United States
(12) Patent Application Publication
(10) Pub. No.: US 2007/0231017 A1
(43) Pub. Date: Oct. 4, 2007

(54) TONER CARTRIDGE AND IMAGE FORMING APPARATUS

(75) Inventor: Tsutomu Sato, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/694,577

(22) Filed: Mar. 30, 2007

(30) Foreign Application Priority Data
Mar. 30, 2006 (JP) 2006-093926

(51) Int. Cl. G03G 15/08

(52) U.S. Cl. 399/262; 399/263

(57) ABSTRACT

There is provided a technology capable of preventing toner from remaining on the bottom part of a toner storing section of a toner cartridge mounted to an image forming apparatus and of contributing to improve the image quality in an image forming processing.

A toner cartridge attachably/detachably mounted to an image forming apparatus and supplies toner to the image forming apparatus comprises: a storing section that stores toner and is provided with a discharge port for discharging the toner stored therein; a conveying member that guides the toner in the storing section to the discharge port; an agitating member that rotates around a predetermined rotational axis in the storing section so as to guide the toner stored in the storing section to the conveying member while agitating the toner; and a plurality of mutually independent elastic members provided at a tip portion of the agitating member so as to extend substantially parallel to the predetermined rotational axis.

### BACKGROUND OF THE INVENTION

1. Field of the Invention

The present invention relates to an image forming processing, and particularly, to a technology that improves the image quality in an image forming processing.

2. Description of the Related Art

There is a conventional toner cartridge that has: a storing section that stores toner and is provided with a discharge port for discharging the toner stored therein; and an agitating member that is rotatably pivoted in the storing section conveys the toner, while agitating the toner stored in the storing section by rotary-driving, along the inner wall and discharges it from the discharge port. The agitating member is configured that the outer circumference thereof is arranged in a position adjacent to the inner wall of the storing section.

However, in the above conventional toner cartridge, a gap is formed between the agitating member and the inner wall of the storing section. Thus, when the residual amount of toner in the storing section is low, the toner accumulates in the gap between the agitating member and the inner wall of the storing section, resulting in a problem that the toner cannot be discharged by the agitating member.

In order to solve this problem, there is disclosed a toner cartridge comprising: a storing section that stores toner and is provided with a delivery port for delivering toner therein; and an agitating member that is connected to a rotating shaft pivoted in the storing section, conveys the toner, while agitating the toner stored in the storing section by driving the rotating shaft to rotate, along the inner wall. The agitating member is provided with a conveying member including a base that has a predetermined elastic deformation on the rotating shaft side and a tip portion that is arranged radially outside the base, slides on the inner wall of the storing section and has a larger elastic deformation than the base (for example, refer to Jpn. Pat. Appln. Laid-Open Publication No. 10-282774).

However, in this case, when the tip portion of the conveying member slides on the inner surface of the storing section, stress is exerted on the toner accumulated on the inner wall by the sliding friction of the tip portion and storing section, changing the nature of the toner and producing sometimes clamp (so-called coarse particle powder). The production of such clamp results in the creation of a clamp image on the printing surface of paper, inhibiting the improvement of image quality in an image forming processing.

### SUMMARY OF THE INVENTION

Embodiments of the present invention are aimed to provide a technology capable of preventing toner from remaining on the bottom part of a toner storing section of a toner cartridge mounted to an image forming apparatus and of contributing to improve the image quality in an image forming processing.

In order to solve the above problem, a toner cartridge according to one embodiment of the present invention is attachably/detachably mounted to an image forming apparatus and supplies toner to the image forming apparatus, and comprises: a storing section that stores toner and is provided with a discharge port for discharging the toner stored therein; a conveying member that guides the toner in the storing section to the discharge port; an agitating member that rotates around a predetermined rotational axis in the storing section so as to guide the toner stored in the storing section to the conveying member while agitating the toner; and a plurality of mutually independent elastic members provided at a tip portion of the agitating member so as to extend substantially parallel to the predetermined rotational axis.

In addition, a toner cartridge according to one embodiment of the present invention is attachably/detachably mounted to an image forming apparatus and supplies toner to the image forming apparatus, and comprises: a storing means for storing toner and is provided with a discharge port for discharging the toner stored therein; a conveying means for guiding the toner in the storing means to the discharge port; an agitating means for rotating around a predetermined rotational axis in the storing section so as to guide the toner stored in the storing means to the conveying means while agitating the toner; and a plurality of mutually independent toner transfer means provided at a tip portion of the agitating means so as to extend substantially parallel to the predetermined rotational axis.

In addition, an image forming apparatus according to one embodiment of the present invention comprises: a toner cartridge configured as described above; a developing section that forms a toner image on a photosurface of a photoconductor by toner supplied from the toner cartridge; and a transfer section that transfers the toner image formed on the photosurface by the developing section to a sheet.

In addition, a toner conveying method according to one embodiment of the present invention is, in a toner cartridge attachably/detachably mounted to an image forming apparatus and supplies toner to the image forming apparatus, comprising: conveying toner located at a predetermined position in a storing section that stores toner to a discharge port by a conveying member, the storing section being provided with a discharge port for discharging toner stored therein; guiding the toner stored in the storing section to the predetermined position while agitating the toner by an agitating member rotating around a predetermined rotational axis in the storing section; and transferring the toner adhered to the inner wall of the storing section toward the predetermined position by an elastic sheet member that is provided at a tip portion of the agitating member so as to extend substantially parallel to the predetermined rotational axis and divided into a plurality of sections in a direction substantially parallel to the rotational axis so that each of the divided sections may be independently deformed elastically.

### BRIEF DESCRIPTION OF THE DRAWINGS

FIG. 1 is a schematic perspective view showing an inner structure of an image forming apparatus 1 according to a first embodiment of the present invention;

FIG. 2 is an exploded perspective view of a toner cartridge embodied according to the present invention;

FIG. 3 is a side view showing an assembled toner cartridge;

FIG. 4 is a cross sectional perspective view showing the toner cartridge;

FIG. 5 is a cross sectional view showing configurations of a sweeping-out sheet, agitating paddle and case;

FIG. 6 is a table showing the experimental results in a case where no sweeping-out sheet is fitted to a conveying paddle and for three different fitting angles in a case where a sweeping-out sheet is fitted to the conveying paddle; and

FIG. 7 is a cross sectional view showing a cross section of a toner cartridge according to a second embodiment of the present invention.

### DESCRIPTION OF THE EMBODIMENTS

Now, the embodiments of the present invention will be described with reference to the accompanying drawings.

### First Embodiment

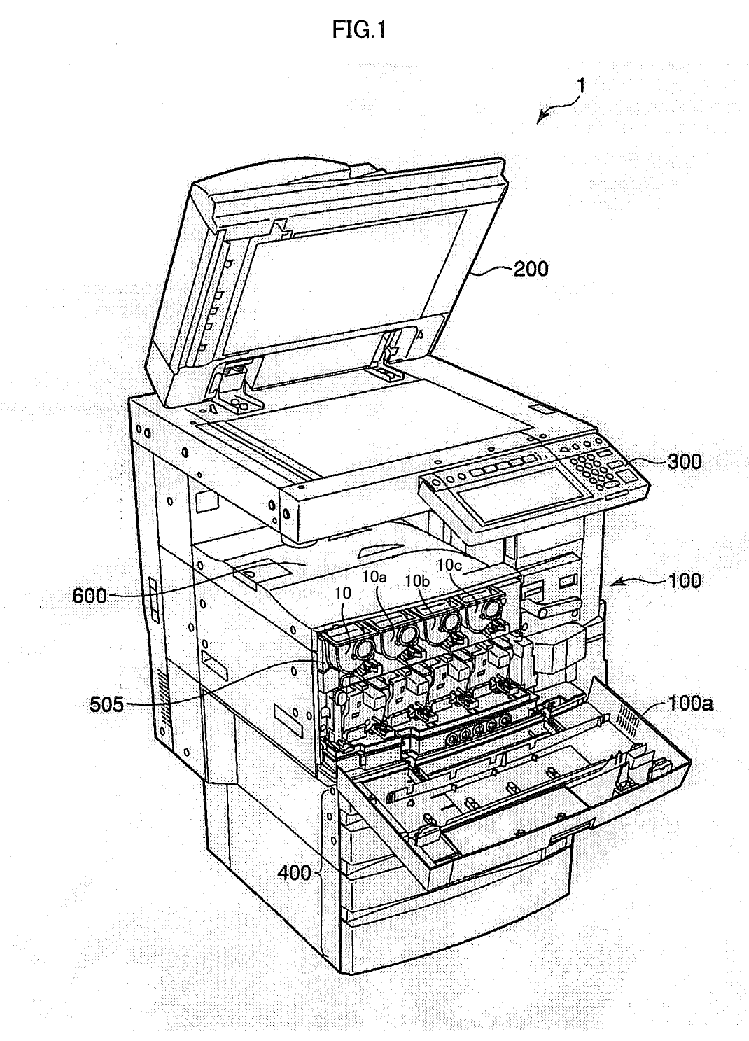

FIG. 1 is a schematic perspective view showing an inner structure of an image forming apparatus 1 according to a first embodiment of the present invention.

As shown in FIG. 1, this image forming apparatus 1 is a so-called “quadruple tandem type” color copying machine and is configured to comprise: a copying machine main unit 100; a platen cover 200; a control panel 300; and a plurality of paper feed cassettes 400.

The color copying machine main unit 100 plays a main role in forming an image and is provided openably and closably with a cover 100a on the front surface thereof. When this cover 100a is opened, there are provided in parallel with one another on the upper side thereof a first toner cartridge 10, a second toner cartridge 10a, a third toner cartridge 10b and a fourth toner cartridge 10c. The platen cover 200 is provided rotatably around one end thereof on the copying machine main unit 100. The control panel 300 is an input section that is used for copying operations and is provided on the upper surface of the copying machine main unit 100. The paper feed cassettes 400 are used to contain sheets of paper and are provided attachably/detachably on the lower side of the copying machine main unit 100. Further, a paper discharge unit 600 is provided above the first to fourth toner cartridges 10 to 10c provided in parallel with one another.

Each of the first to fourth toner cartridges 10 to 10c is detachably/attachably provided from/to a cartridge holding mechanism 505. The first to fourth toner cartridges 501 to 504 supply toners of yellow, magenta, cyan and black. In addition, the first to fourth toner cartridges 10 to 10c are configured basically identical to one another. Thus, in the present embodiment, the specific configuration of the first toner cartridge 10 will be described (hereinafter, simply referred to as “toner cartridge 10”), and the descriptions of the second to fourth toner cartridges 10a to 10c will be omitted.

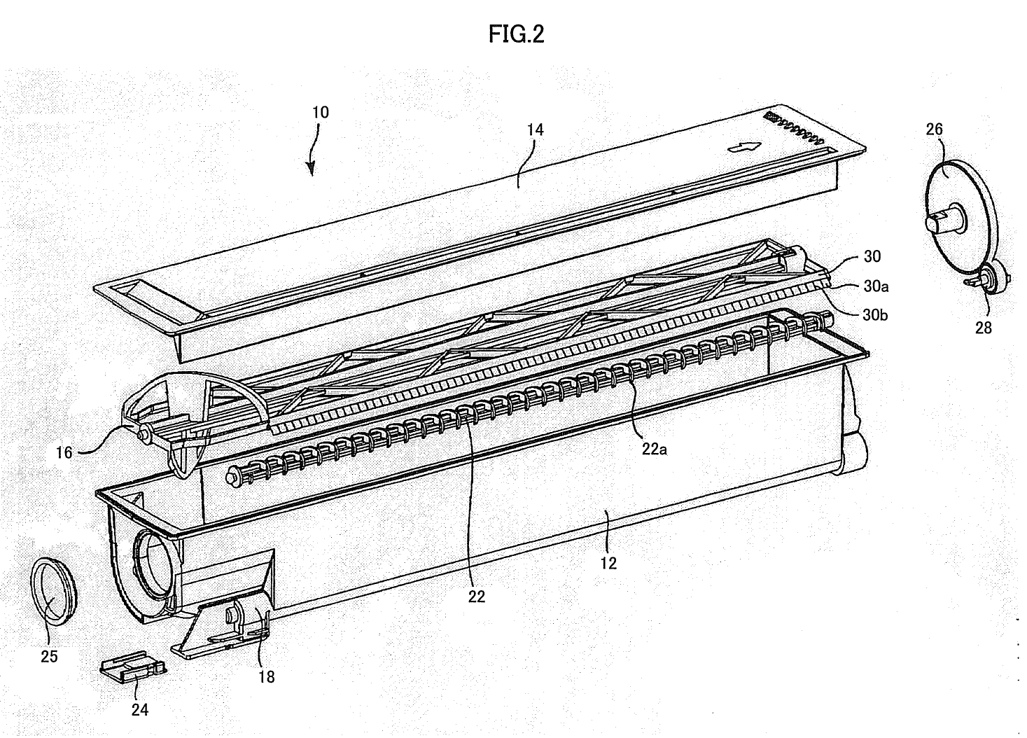

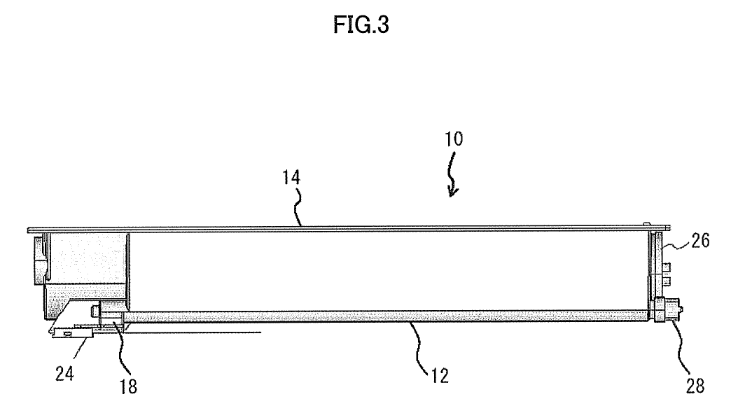

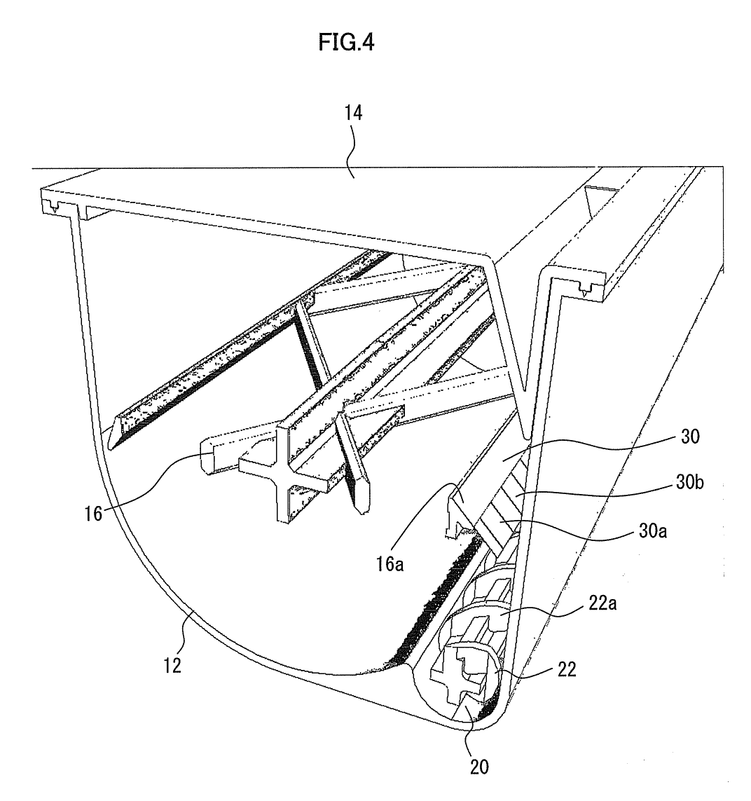

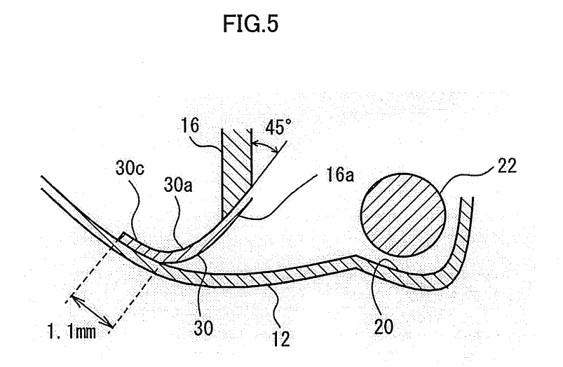

FIG. 2 is an exploded perspective view of a toner cartridge embodied according to the present invention, FIG. 3 is a side view showing an assembled toner cartridge, FIG. 4 is a cross sectional perspective view showing the toner cartridge, and FIG. 5 is a cross sectional view showing configurations of a sweeping-out sheet, agitating paddle and case. The toner cartridges according to the present embodiment have a role of supplying toners for forming a toner image transferred onto a sheet.

The toner cartridge 10 forms a sealed space composed of a case (storing section, storing means) 12 and a lid (storing section) 14 closing the opening of the case 12. Toner is contained in this sealed space. In the case 12, there is provided an agitating paddle (agitating member, agitating means) 16 that rotates around a predetermined rotational axis in the case 12 to guide the toner stored in the case 12 to a predetermined position (in the vicinity of a groove 20 described later) while agitating it. Both end sections of the agitating paddle 16 are rotatably supported in the central sections of the walls of both ends of the case 12 respectively.

In the bottom part of one side wall of the case 12, there are provided a discharge port 18 that discharges the stored toner outside the case 12 and a groove 20 that extends to the discharge port 18 substantially along the entire length of one side wall. In this groove 20, there is provided rotatably an auger (conveying member, conveying means) 22 over the entire length of the groove 20. On the auger 22, there is provided a spiral blade 22a over the entire length thereof, guiding the toner in the groove 20 (toner located in a predetermined position) to the discharge port 18 by driving the auger 22 to rotate. A shutter 24 that switches the opening/closing of the discharge port 18 is slidably fitted to the bottom part of the case 12, and a supply port cap 25 is pushed into the left end surface of the case 12 shown in FIG. 2.

On the outer wall of right end side of the case 12 in FIG. 3 there are provided a gear wheel 26 and a coupling gear 28 with engaging with each other. The coupling gear 28 can be driven to rotate by the driving force from a driving source (not shown). One end of the auger 22 is connected to the coupling gear 28 so that they may be rotated together, rotating the auger 22 by the rotary drive of the coupling gear 28 to guide the toner to the discharge port 18 and drive the gear wheel 26 to rotate. The agitating paddle 16 is connected to the gear wheel 26 so that they are rotated together, and the agitating paddle 16 rotates with the gear wheel 26 to suitably agitate the toner contained in the case 12 and deliver it to the auger 22.

At least at one outside end section (tip portion) in a turning radial direction of the agitating paddle 16, there is arranged a sweeping-out sheet (elastic sheet member, toner transfer means) 30 so as to extend substantially parallel to the rotational axis of the agitating paddle 16, the sweeping-sheet being divided into a plurality of sections in a direction substantially parallel to the rotating shaft so that each of the divided sections can be independently elastically deformed. On a plane substantially perpendicular to the rotational axis of the agitating paddle 16, the sweeping-out sheet 30 is attached to an attachment surface 16a of the outside end section in a turning radial direction of the agitating paddle 16 at an angle tilted by about 45 degrees from the turning radial direction to the backside of the rotational direction. The sweeping-out sheet 30 is attached at one end thereof by a double-sided adhesive tape to the attachment surface 16a. The sweeping-out sheet 30 is an elastically deformable strip-like PET sheet having a thickness of about 0.05 mm.

A sweeping-out section 30a that is a free end not secured to the attachment surface 16 of the sweeping-out sheet 30 protrudes from the outer circumference of the agitating paddle 16 further in an outer diameter direction, and the tip portion 30c is elastically deformed to come into contact with the bottom part of the case 12. The length of the tip portion 30c that comes into contact with a semi-cylindrical inner wall of the bottom part of the case 12 is preferably 1.1 mm. The length of the sweeping-out section 30a is set to 5.4 mm, in order to fix the length of the tip portion 30c to this dimension. In the sweeping-out section 30a, there are provided, in a direction substantially parallel to the rotational axis, a plurality of notched sections 30b at an interval of 5 mm over the entire length of a width direction.

Now, the effects of the present embodiment will be described. When driving force is transmitted from a driving source (not shown) and the coupling gear 28 is driven to rotate, the auger 22 is driven to rotate in an integrated manner, and further, the conveying paddle 16 is driven to rotate via the gear wheel 26. Thereby, the conveying paddle 16 agitates and delivers the toner to the auger 22, and the auger 22 conveys the conveyed toner to the discharge port 18 to discharge the tone from the discharge port 18. In the beginning of using the toner cartridge 10, the amount of toner in the case 12 is large. However, even if the sweeping-out sheet 30 rotates together with the conveying paddle 16, the toner that comes into contact, with the weeping-out section 30a flows to the backside of the sweeping-out section 30a through the notched sections 30b, thereby preventing the sweeping-out sheet 30 from inhibiting the rotations of the conveying paddle 16.

In addition, since a gap is formed between the outer circumference of the agitating paddle 16 and the inner wall of the case 12, the toner remaining in this gap cannot be conveyed by the agitating paddle 16 when the amount of toner in the case 12 becomes small. However, the tip portion 30c of the sweeping-out sheet 30 comes into contact with the bottom part of the case 12, thereby enabling the tip portion 30c to deliver the toner remaining in the gap to the auger 22. As a result, the amount of the toner remaining in the case 12 can be reduced.

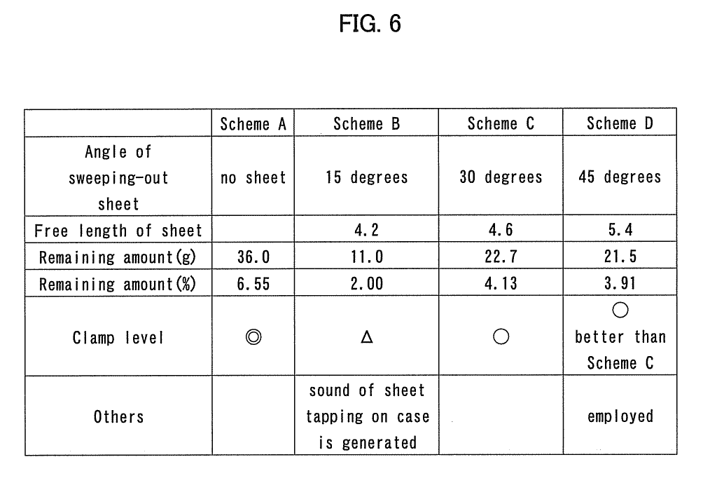

FIG. 6 is a table showing the experimental results in a case where no sweeping-out sheet 30 is fitted to the conveying paddle 16 and for three different fitting angles in a case where the sweeping-out sheet 30 is fitted to the conveying paddle 16.

In FIG. 6, the angle of the sweeping-out sheet 30 is an angle to a straight line that is perpendicular to the rotational axis of the agitating paddle 16 and connects the outer circumference of the agitating paddle 16. The larger the value of the angle is, the more horizontal the sweeping-out sheet 30 is.

In addition, “free length of the sheet” in Schemes B, C and D, that is, the length of the sweeping-out section 30a, is a length to fix the length of the tip portion 30c that comes into contact with the bottom part of the case 12 to 1.1 mm.

Remaining amount (g) denotes the weight of unused toner in the cartridge 10. Further, remaining amount (%) is a value that is evaluated in % of the weight of remaining toner with respect to a full scale value of 550 g. A value of equal to or less than 5% is set as a standard value.

Further, a method of confirming the clamp level comprises: laying the toner discharged from the toner cartridge on a sieve; sucking the toner by a sweeper from the rear side; and checking the state of remaining masses of toner with eyes to make an evaluation.

Now, an evaluation for each scheme will be described. In Scheme A, since no sweeping-out sheet 30 is fitted to the conveying paddle 16, there is no friction due to the contact between the tip portion 30c of the sweeping-out sheet 30 and the case 12. Thus, no clamps are produced in toner. However, there remains much toner in the gap between the outer circumference of the conveying paddle 16 and the case 12, resulting in a remaining amount of 6.55% that exceeds the standard value of 5%.

In Scheme B, due to a small fitting angle of the sweeping-out sheet 30 to the conveying paddle 16, the tip portion 30c of the sweeping-out sheet 30 coming into contact with the case 12 is subjected to a large elastic deformation. Thus, the friction between the tip portion 30c and the case 12 becomes larger, and the toner remaining on the bottom part of the case 12 can be swept out more, resulting in a remaining amount of 2.00% that is the smallest value among the four schemes. However, this large friction produces more clamps. In addition, when the tip portion 30c is rotated to the position of the auger 22, it does not come into contact with the inner wall of the case 12, recovering the original linear shape once. Subsequently, when the tip portion 30c is rotated to come into contact with the inner wall of the case 12 again, it is elastically deformed as shown in FIG. 5. At this time, in Scheme B, since the elastic deformation of the tip portion 30c is large, a sound of tapping on the case 12 is generated when the tip portion 30c comes into contact with the case 12.

In Scheme C, the remaining amount of toner is 4.13% that is within the standard value. The clamp level is inferior to Scheme A, but favorable.

In Scheme D, the remaining amount of toner is 3.91% that is within the standard value and is less than that of Scheme C. In addition, clamp level is inferior to Scheme A, but more favorable than that of Scheme C. From above, the fitting angle of the sweeping-out sheet 30 of 45 degrees in Scheme D is determined to be the most preferable. From such experimental results, the fitting angle of the sweeping-out sheet 30 of about 40 degrees to 50 degrees (in particular 45 degrees) is proved to be preferable. The sweeping-out sheet 30 is preferably a PET-sheet having a thickness of about 0.04 mm to 0.06 mm (in particular 0.05 mm).

Based on the experimental results shown in FIG. 6, the toner cartridge 10 according to the present embodiment employs a configuration in which the sweeping-out sheet 30 is provided under the condition of Scheme D.

In addition, the size, fitting angle, material and shape of the sweeping-out sheet 30 are not limited to those of the above embodiment and may be changed arbitrarily depending on the size of a toner cartridge and components. However, the length of the sweeping-out sheet 30 on a plane perpendicular to the rotational axis of the agitating paddle 16 is preferably set to the length that comes into contact elastically with the inner wall of the storing section due to a predetermined pushing force.

### Second Embodiment

Now, a second embodiment of the present invention will be described.

The present embodiment is a variation of the above first embodiment. Hereinafter, parts having similar functions as ones described in the first embodiment are denoted by the same reference symbols, and the descriptions thereof will be omitted.

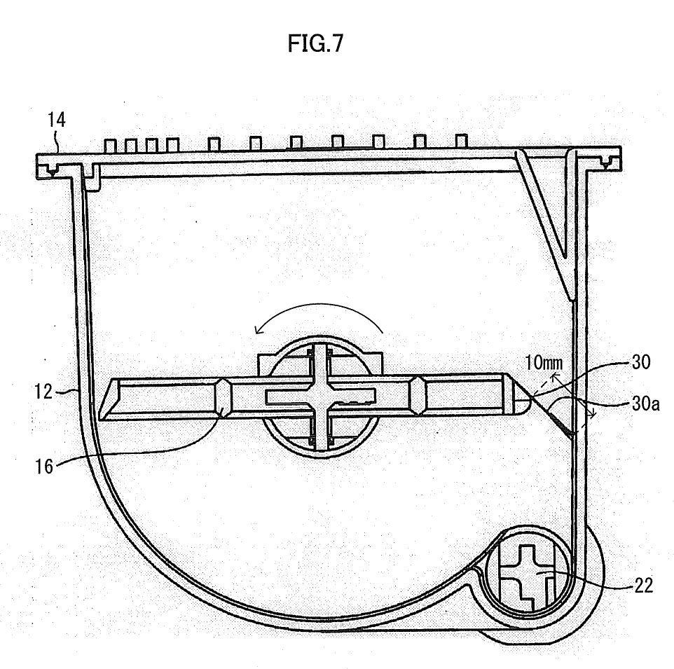

FIG. 7 is a cross-sectional view showing a cross section of a toner cartridge according to the present embodiment.

As shown in FIG. 7, in the toner cartridge according to the present embodiment, the length of the sweeping-out section 30a is set, for example, to “10 mm”. Thereby, the tip portion of the sweeping-out sheet 30 can collide not only with a R-shaped inner wall below the storing section of the toner cartridge, but also, as shown in FIG. 7, with the side wall of the storing section (side wall inner surface on the right side in FIG. 7). By this contact action, the toner adhering to the right side surface of the storing section can be scraped off, enabling the amount of toner remaining on the side wall of the storing section in the toner cartridge to be reduced. In addition, an example in which the length of the sweeping-out section 30c is 10 mm is described here, however, the length is not limited thereto and may be the length with which the tip of the sweeping-out sheet 30 can collide with the side wall in the storing section with a suitable pushing force (with a pushing force capable of scraping off the toner adhered to the side wall).

As described above, according to the above embodiments, in order to sweep out the toner adhered to the inner wall of the storing section, the tip portion of the elastically deformable sweeping-out section is brought into contact with the inner wall of the storing section with being obliquely tilted backside of the rotational direction, reducing the friction force generated between the tip portion and the inner wall. Therefore, the amount of toner remaining in the storing section is reduced. When discharging the toner remaining on the bottom part of the storing section by sweeping out it by the sweeping-out sheet, less stress is applied to the toner swept out by the tip portion of the sweeping-out sheet. As a result, generation of clamps due to the changed nature of toner can be suppressed, thereby preventing a clamp image from being generated on the printing surface of a sheet.

In addition, in a case where a large amount of toner is held in the storing section, the toner that comes into contact with the sweeping-out sheet flows to the backside of the elastic sheet member through the notched sections even though the elastic sheet member is rotated together with the agitating member. Therefore, the sweeping-out sheet does not inhibit the rotations of the agitating member, so that an increase in power needed for driving the agitating member to rotate can be prevented.

In addition, according to the above embodiments, there can be provided an image forming apparatus comprising: a toner cartridge that has the above configuration; a developing section that forms a toner image on a photosurface of a photo conductor by the toner supplied from the toner cartridge; and a transfer section that transfers the toner image formed by the developing section on the photosurface to a sheet.

The present invention has been described in accordance with the specific embodiments, it is obvious to those skilled in the art that various changes and modifications may be made without departing from the spirit and scope of the present invention.

As described above in detail, according to the present invention, there can be provided a technology capable of preventing toner from remaining on the bottom part of the toner storing section of the toner cartridge mounted to the image forming apparatus and of contributing to improve the image quality in an image forming processing.

What is claimed is:

1. A toner cartridge attachably/detachably mounted to an image forming apparatus and supplies toner to the image forming apparatus, comprising:
a storing section that stores toner and is provided with a discharge port for discharging the toner stored therein;
a conveying member that guides the toner in the storing section to the discharge port;
an agitating member that rotates around a predetermined rotational axis in the storing section so as to guide the toner stored in the storing section to the conveying member while agitating the toner; and
a plurality of mutually independent elastic members provided at a tip portion of the agitating member so as to extend substantially parallel to the predetermined rotational axis.

2. The toner cartridge according to claim 1, wherein
the vicinity of a bottom part of the inner wall of the storing section is a semi-cylindrical shape; and
the length of each of the elastic members on a plane perpendicular to the rotational axis of the agitating member is set to the length that comes into contact elastically with the inner wall of the storing section due to a predetermined pushing force.

3. The toner cartridge according to claim 1, wherein
the elastic members are arranged at an angle tilted by a predetermined degree from the turning radial direction of the agitating member to the backside of the rotational direction thereof on a plane substantially perpendicular to the predetermined rotational axis.

4. The toner cartridge according to claim 3, wherein
the predetermined angle is set to an angle between 40 degrees to 50 degrees.

5. The toner cartridge according to claim 1, wherein
a plurality of notches are formed in each of the elastic
members in a direction substantially parallel to the rotational axis.

6. The toner cartridge according to claim 1, wherein
each of the elastic members is a PET-sheet having a thickness of about 0.04 mm to 0.06 mm.

7. The toner cartridge according to claim 1, wherein
the length of each of the elastic members on a plane perpendicular to the rotational axis of the agitating member is set to the length that comes into contact with at least a part of the side wall section in the inner wall of the storing section.

8. A toner cartridge attachably/detachably mounted to an image forming apparatus and supplies toner to the image forming apparatus, comprising:
storing means for storing toner and is provided with a discharge port for discharging the toner stored therein;
conveying means for guiding the toner in the storing means to the discharge port;
agitating means for rotating around a predetermined rotational axis in the storing section so as to guide the toner stored in the storing means to the conveying means while agitating the toner;
and a plurality of mutually independent toner transfer means provided at a tip portion of the agitating means so as to extend substantially parallel to the predetermined rotational axis.

9. The toner cartridge according to claim 8, wherein
the vicinity of a bottom part of the inner wall of the storing means is semi-cylindrical shape; and
the length of each of the toner transfer means on a plane perpendicular to the rotational axis of the agitating means is set to the length that comes into contact elastically with the inner wall of the storing means due to a predetermined pushing force.

10. The toner cartridge according to claim 8, wherein
the toner transfer means are arranged at an angle tilted by a predetermined degree from the turning radial direction of the agitating means to the backside of the rotational direction thereof on a plane substantially perpendicular to the predetermined rotational axis.

11. The toner cartridge according to claim 10, wherein
the predetermined angle is set to an angle between 40 degrees to 50 degrees.

12. The toner cartridge according to claim 8, wherein
a plurality of notches are formed in each of the toner transfer means in a direction substantially parallel to the rotational axis.

13. The toner cartridge according to claim 8, wherein
each of the toner transfer means is a PET-sheet having a thickness of about 0.04 mm to 0.06 mm.

14. The toner cartridge according to claim 8, wherein
the length of each of the toner transfer means on a plane perpendicular to the rotational axis of the agitating means is set to the length that comes into contact with at least a part of the side wall section in the inner wall of the storing means.

15. An image forming apparatus, comprising:
a toner cartridge according to claim 1;
a developing section that forms a toner image on a photosurface of a photo conductor by toner supplied from the toner cartridge; and
a transfer section that transfers the toner image formed on the photosurface by the developing section to a sheet.
